(19) United States
(12) Patent Application Publication
(10) Pub. No.: US 2002/0148686 A1
(43) Pub. Date: Oct. 17, 2002

(54) Automatic oil changing apparatus for automatic transmission of automobile

(76) Inventors: Hwan Yun, Doochun-shi (KR); Yon Hwa Kim, Doochun-shi (KR)

Correspondence Address: STAAS & HALSEY LLP, 700 11TH STREET, NW, SUITE 500, WASHINGTON, DC, 20001, US

(21) Appl. No.: 10/122,245

(22) Filed: Apr. 16, 2002

(30) Foreign Application Priority Data
Apr. 17, 2001 (KR) 2001-20363
Sep. 5, 2001 (KR) 2001-54346

(51) Int. Cl. F16C 3/14

(52) U.S. Cl. 184/1.5

(57) ABSTRACT

An automatic oil changing apparatus for an automatic transmission is disclosed. The apparatus includes an oil line changing unit which includes four two-way solenoid operated valves provided at first and second double lines connected to a supply line and a discharge line of the automatic transmission, such that the two two-way solenoid operated valves provided at each of the first and second double lines are opposite to each other in flow direction and are changed with each other in flow direction in the state of reverse connection; a solenoid operated valve connected to the discharge line to interrupt discharge of oil when initial oil pressure of the automatic transmission is checked; a used oil tank connected to the solenoid operated valve; a motor pump connected to the supply line to supply oil; a fresh oil tank connected to the motor pump; a solenoid operated valve provided between the supply line and the discharge line, which is adapted to be opened when initial oil pressure of the automatic transmission is checked and to be closed when discharge and supply of oil are initiated; and a pressure gauge connected to the solenoid operated valve provided between the supply line and the discharge line to check pressure of oil in the automatic transmission.

### BACKGROUND OF THE INVENTION

1. Field of the Invention

The present invention relates to an automatic oil changing apparatus for an automatic transmission of an automobile, and more particularly to an automatic oil changing apparatus for an automatic transmission of an automobile which is intended to facilitate changing of oil even if an oil supply line and an oil discharge line are incorrectly connected to an oil inlet and an outlet of an automatic transmission, by automatically causing the oil lines to be normally connected.

2. Description of the Prior Art

In general, an automatic transmission commonly contains oil for affording a smooth operation of a torque converter and the automatic transmission. Since the oil must be periodically changed with fresh oil, a manual type of oil changing apparatus is commonly used for the sake of convenience of oil changing.

Such a manual type of oil changing apparatus is disclosed in Korean Utility Model No. 126763. As an improvement to the above-mentioned oil changing apparatus, there is an automatic oil changing apparatus disclosed in Korean Utility Model No. 171413, which is filed by the inventor.

In the above-mentioned conventional automatic oil changing apparatus, although oil lines of the automatic oil changing apparatus must be correctly connected such that a supply line of the apparatus is connected to an oil inlet of an automatic transmission while a discharge line thereof is connected to an oil outlet of the automatic transmission (this condition is referred to as “forward connection” while the reverse condition is referred to as “reverse connection”), in order to normally supply fresh oil and to discharge used oil, it is not easy for an operator to differentiate the supplying and discharge lines from each other and to correctly connect lines to the corresponding oil inlet and oil outlet. To change the oil lines which have been incorrectly connected, the oil supply line and the oil discharge line of the automatic oil changing apparatus must be separated from the automatic transmission after an engine of the automobile is stopped, and then must be correctly connected to the oil inlet and oil outlet again, followed by startup of the automobile. Therefore, the changing operation of the lines becomes troublesome. In particular, where an automobile is hoisted to separate an automatic oil changing apparatus from the automobile, the changing operation of lines becomes more troublesome.

Furthermore, since supply of fresh oil and discharge of used oil in the conventional automatic oil changing apparatus are carried out concurrently, a considerable amount of fresh oil is inevitably mixed with used oil in an automatic transmission. Accordingly, excessive fresh oil must be consumed to implement a complete oil change. Moreover, in an automobile having not an oil checking hole and a dipstick, there is no way to precisely check an amount of oil to be changed.

### SUMMARY OF THE INVENTION

Accordingly, the present invention has been made keeping in mind the above problems occurring in the prior art, and an object of the present invention is to provide an automatic oil changing apparatus for an automatic transmission of an automobile which is capable of correctly supplying and discharging oil during an oil changing operation even if the supply line is not correctly connected to the oil inlet or the discharge line is not correctly connected to the oil outlet of the automatic transmission, thereby affording convenient changing of oil without stopping and lifting of the automobile and disconnection of the oil changing apparatus.

Another object of the present invention is to provide an automatic oil changing apparatus for an automatic transmission of an automobile which is adapted to prevent supplying of fresh oil until a certain amount of used oil is discharged, thereby preventing excessive fresh oil from being supplied during an oil changing operation.

A further object of the present invention is to provide an automatic oil changing apparatus for an automatic transmission of an automobile which is capable of finely adjusting a supplied amount of fresh oil and discharging amount of used oil to the initial setting amount, after an oil changing operation.

Still another object of the present invention is to provide an automatic oil changing apparatus for an automatic transmission of an automobile which is adapted to automatically carry out an oil changing operation and to notify an operator of completion of the operation, thereby preventing inconvenience in a manual operation and consumption of operating time, and thereby allowing an operator to easily carry out an oil changing operation while carrying out another operation.

Still another object of the present invention is to provide an automatic oil changing apparatus for an automatic transmission of an automobile which is capable of precisely displaying an oil amount discharged and an oil amount supplied on a display panel where an automobile does not have an oil checking hole and a dipstick, thereby removing a sense of uncertainty.

Still another object of the present invention is to provide an automatic oil changing apparatus for an automatic transmission of an automobile which is capable of controlling oil amount discharged, by providing a control valve, when an oil amount discharged is much more than an oil amount supplied during an oil changing operation.

Still another object of the present invention is to provide an automatic oil changing apparatus for an automatic transmission of an automobile which enables an operator to identify flow of discharged oil by providing an indicator and a temperature sensor between the indicator and a solenoid operated valve, and which also enables an operator to identify malfunction of an automatic transmission (blockage of a cooler, presence of moisture and so on) by measuring temperature of the automatic transmission.

In order to accomplish the above object, the present invention provides an automatic oil changing apparatus for an automatic transmission of an automobile comprising: an oil line changing unit which includes first and second double lines connected to a supply line and a discharge line of the automatic transmission, branch lines of each of the first and second double lines being connected to an oil inlet and an oil outlet of the automatic transmission, respectively, and which further includes four two-way solenoid operated valves provided at the branch lines of the first and second double lines, respectively, such that the two two-way solenoid operated valves provided at each of the first and second double lines are opposite to each other in flow direction and are adapted to allow supply and discharge of oil in the state of forward connection and to be changed with each other in flow direction in the state of reverse connection; a solenoid operated valve connected to the discharge line of the oil line changing unit to interrupt discharge of oil when initial oil pressure of the automatic transmission is checked; a used oil tank connected to a rear end of the solenoid operated valve; a motor pump connected to the supply line of the oil line changing unit to supply oil; a fresh oil tank connected to a rear end of the motor pump; a solenoid operated valve provided between the supply line and the discharge line, which is adapted to be opened when initial oil pressure of the automatic transmission is checked and to be closed when discharge and supply of oil are initiated; and a pressure gauge connected in series to the solenoid operated valve provided between the supply line and the discharge line to check pressure of oil in the automatic transmission.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a circuit diagram of an automatic oil changing apparatus according to the present invention, which is connected in a forward connection state allowing an operator to check initial oil pressure of an automatic transmission;

FIG. 2 is a circuit diagram of the automatic oil changing apparatus, which is connected in the forward connection manner in the state of discharging used oil and supplying fresh oil;

FIG. 3 is a circuit diagram of the automatic oil changing apparatus according to the present invention, which is connected in a reverse connection state allowing on operator to check initial oil pressure of an automatic transmission;

FIG. 4 is a circuit diagram of the automatic oil changing apparatus, which is connected in the reverse connection manner to change oil lines in the state of discharging used oil and supplying fresh oil;

FIG. 5 is a plan view of a panel, which allows an operating condition of the automatic oil changing apparatus according to the present invention to be seen;

FIG. 6 is a circuit diagram of a second embodiment of the present invention, which has functions similar to those of the first embodiment shown in FIG. 1;

FIG. 7 is a circuit diagram of the second embodiment, which has functions similar to those of the first embodiment shown in FIG. 2;

FIG. 8 is a circuit diagram of the second embodiment, which has functions similar to those of the first embodiment shown in FIG. 3;

FIG. 9 is a circuit diagram of the second embodiment, which has functions similar to those of the first embodiment shown in FIG. 4;

FIG. 10 is a circuit diagram of a third embodiment showing a state of forward connection by two manual three-way valves in which oil is circulated;

FIG. 11 is a circuit diagram of the third embodiment showing a state of reverse connection by two manual three-way valves in which oil is circulated;

FIG. 12 is a circuit diagram of the third embodiment showing a state of forward connection by two manual three-way valves in which oil is changed; and

FIG. 13 is a circuit diagram of the third embodiment showing a state of reverse connection by two manual three-way valves in which oil is changed.

### DETAILED DESCRIPTION OF THE INVENTION

This invention will be described in further detail by way of example with reference to the accompanying drawings.

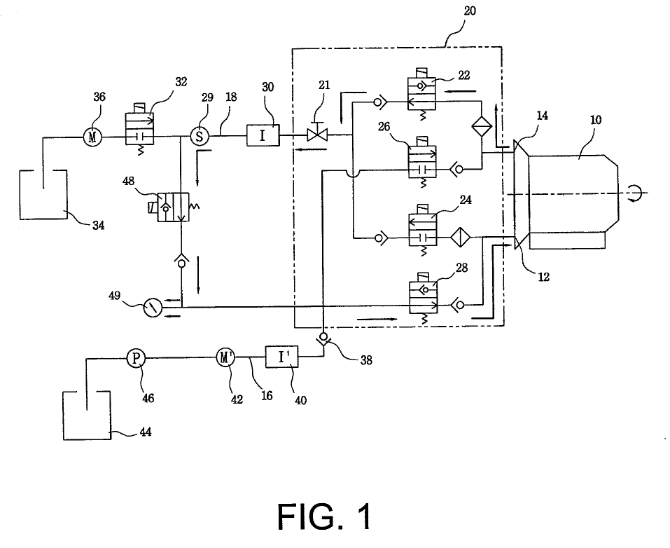

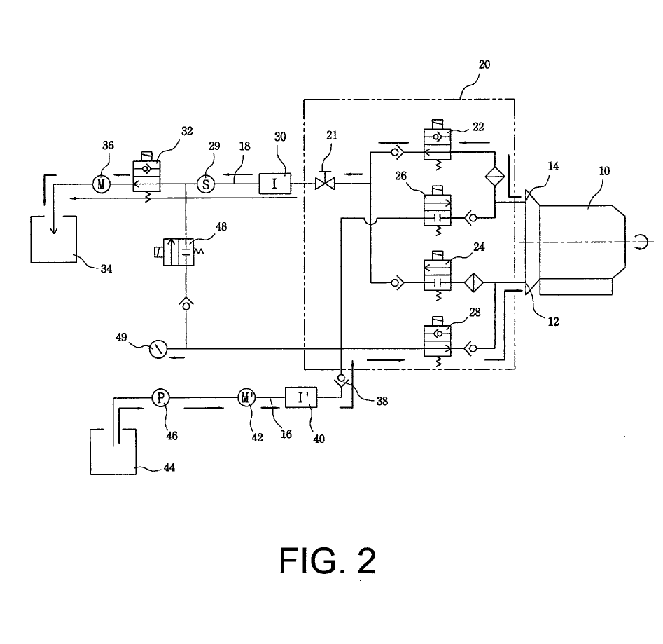

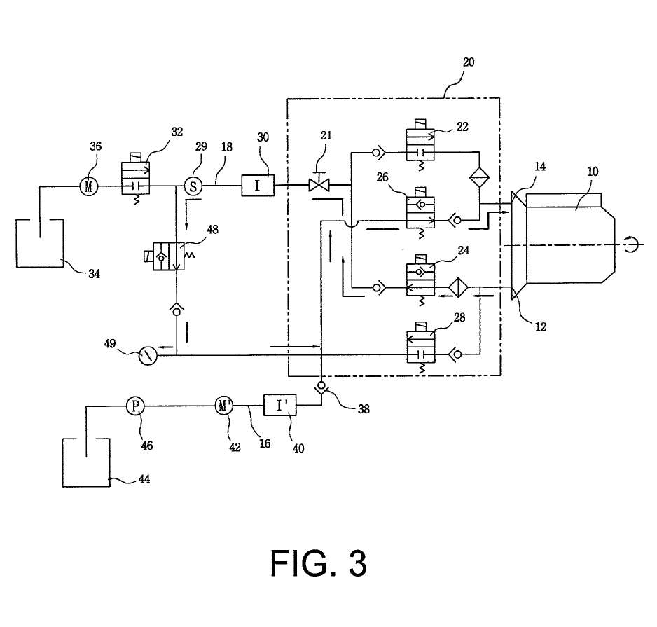

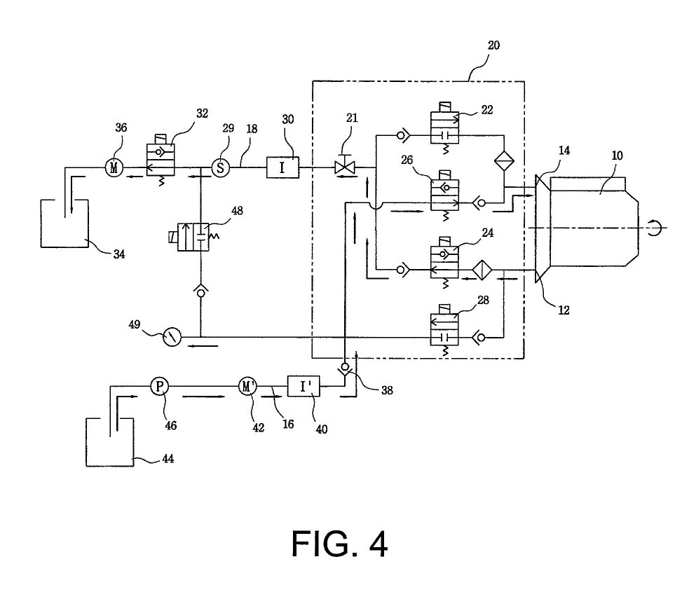

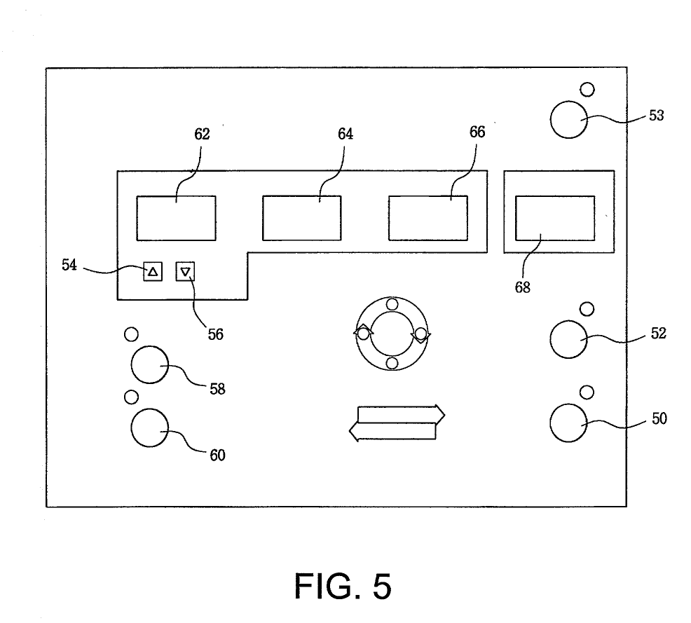

FIG. 1 is a circuit diagram of an automatic oil changing apparatus according to the present invention, which is connected in a forward connection state allowing an operator to check initial oil pressure of an automatic transmission, FIG. 2 is a circuit diagram of the automatic oil changing apparatus, which is connected in the forward connection manner in the state of discharging used oil and supplying fresh oil, FIG. 3 is a circuit diagram of the automatic oil changing apparatus according to the present invention, which is connected in a reverse connection state allowing on operator to check initial oil pressure of an automatic transmission, FIG. 4 is a circuit diagram of the automatic oil changing apparatus, which is connected in the reverse connection manner to change oil lines in the state of discharging used oil and supplying fresh oil, and FIG. 5 is a plan view of a panel which allows an operating condition of the automatic oil changing apparatus according to the present invention to be seen.

A connection state of an automatic oil changing apparatus according to the present invention, in which a hydraulic circuit of the apparatus is connected to an automatic transmission in a forward connection manner, is first described.

As shown in FIGS. 1 and 2, the automatic transmission 10 is provided with an oil inlet 12 and an oil outlet 14. The oil inlet 12 and the oil outlet 14 are connected to a supply line 16 and a discharge line 18 of the automatic transmission 10 such that an oil line changing unit 20 is provided between the lines 16 and 18 and the oil inlet and outlet 12 and 14.

The oil line changing unit 20 is configured such that the supply line 16 and the discharge line 18 of the automatic oil changing apparatus are connected to two double lines, respectively. Branch lines of the double lines of the supply line 16 and the discharge line 18 are connected to the oil inlet 12 and the oil outlet 14, respectively. The branch lines of the double line of the discharge line 18 are provided with two-way solenoid operated valves 22 ad 24 such that flow directions of the two-way solenoid operated valves 22 and 24 are opposite to each other. In the case of forward connection, the solenoid operated valve 22 is normally open while the solenoid operated valve 24 is normally closed. The branch lines of the double line of the discharge line 16 are provided with two-way solenoid operated valves 26 ad 28 such that flow directions of the two-way solenoid operated valves 26 and 28 are opposite to each other. In the case of the forward connection, the solenoid operated valve 26 is normally closed, while the solenoid operated valve 28 is normally open.

The discharge line 18 rearwardly connected to the oil line changing unit 20 is provided with an oil flow regulating valve 21, which is adapted to control oil amount discharged in the case of an automobile with discharged amount of oil excessively larger than supplied amount of fresh oil. The discharge line 18 is further provided with an indicator 30 for indicating flow of discharged oil, and provided at the rear of the indicator 30 with a temperature sensor 29 for measuring temperature of oil in the automatic transmission. Furthermore, the discharge line 18 is provided with a two-way solenoid operated valve 32 adapted to open or close the discharge line to allow used oil discharged from the automatic transmission 10 to flow toward used oil tank 34 or to interrupt the flow, and provided at the rear of the solenoid operated valve 32 with a flow meter for measuring amount of oil discharged.

The oil flow regulating valve 21 serves to regulate discharge rate of transmission oil to cause pumping pressure to be at 1.5 kg/cm² or lower by checking a pressure gauge attached to a main panel, i.e., by checking pumping pressure of the automatic transmission to see whether proper oil amount is supplied. The temperature sensor 29 serves to check whether temperature of the oil is higher or lower than normal (90-100° C.) and to notify an operator of the temperature, thereby allowing the operator to confirm failure of the transmission.

The supply line 16 rearwardly connected to the oil line changing unit 20 is provided with a check valve 38 for preventing backflow of oil, and provided at the rear of the check valve with an indicator 40 for indicating flow of supplied oil. Furthermore, the supply line 16 is provided with a flow meter 42 for measuring amount of oil supplied, and provided with a motor pump 46 for pumping oil from a fresh oil tank 44.

A solenoid operated valve 48 is connected between the supply line 16 and the discharge line 18, which is adapted to be opened when the initial oil pressure of the automatic transmission 10 is checked, and to be closed when discharge and supply of oil is initiated. Between the solenoid operated valve 48 and the supply line 16 is connected a pressure gauge 49.

Referring to FIGS. 3 and 4, there is shown the automatic oil changing apparatus, in which the supply line 16 and the discharge line 18 are connected in the manner of reverse connection, opposite to the forward connection. The configuration of reverse connection is substantially identical to that in the manner of forward connection, except that the solenoid operated valves 24 and 26 are normally open while the solenoid operated valves 22 and 28 are normally closed.

FIG. 5 shows a panel which is provided with various operating buttons and windows for displaying the operating condition of the automatic oil changing apparatus according to the present invention. More specifically, the panel includes an on-off power switch 53, a starting button 50 for starting up or stopping the motor pump 46, an oil line changing button 52 for changing oil lines when the automatic oil changing apparatus is connected in the reverse connection manner, an up button 54 and a down button 56 for setting amount of oil to be changed, a fine discharge button 58 for finely discharging used oil by a manual manipulation after an oil changing operation is completed, a fine supply button 60 for finely replenishing fresh oil by a manual manipulation, a setting window 62 for displaying set amount of oil, a fresh oil supplying window 64 for displaying amount of fresh oil supplied, a used oil discharging window 66 for displaying amount of used oil discharged, and a temperature window 68 for displaying temperature of oil in the automatic transmission.

An operation of the automatic oil changing apparatus according to the present invention will now be described.

An automobile is first started after the oil line changing unit 20 of the automatic oil changing apparatus is connected to an automatic transmission 10. At this point, if the automatic oil changing apparatus and the automatic transmission are connected in the manner of forward connection, oil of the automatic transmission 10 is circulated such that the oil is discharged through the oil outlet 14, and then flows into the automatic transmission 10 by way of the solenoid operated valve 22, the indicator 30, the solenoid operated valve 48, the solenoid operated valve 28 and the oil inlet 12, in this order, as shown in FIG. 1. Accordingly, pressure of oil of the automatic transmission is displayed on the pressure gauge 49. Since the forward connection of the automatic oil changing apparatus is identified by the pressure gauge 49, it is possible to carry out a normal oil changing operation.

At this point, a power switch (not shown) of the oil changing apparatus is already turned on, default amount of 7, which is previously set as an oil amount to be supplied, is displayed on the setting window 62. An operator can push the up button 54 or the down button 56 to adjust set oil amount. In this case, the setting amount can be adjusted in 0.5 increments.

When the starting button 50 is pushed after the oil amount is set, the solenoid operated valve 32 goes into the state of normally open while the solenoid operated valve 48 goes into the state of normally closed, so that used oil is discharged from the automatic transmission 10 through the oil outlet 14 and then introduced into the used oil tank 34 by oil pressure of the automatic transmission 10.

In this case, the motor pump 46 for supplying fresh oil is not activated. If the motor pump 46 for supplying fresh oil is activated during discharge of used oil, since excessive fresh oil is mixed with used oil in the automatic transmission, excessive fresh oil is consumed to achieve a complete oil change. Accordingly, when the discharge of a certain amount of used oil is detected by the flow meter, the motor pump 46 is activated to supply fresh oil, thereby minimizing consumption of fresh oil.

Since supply fresh oil begins after a certain amount of used oil in the automatic transmission is discharged, a discharge of a predetermined preset amount of used oil is generally completed before supply of fresh oil is completed. At this time, when an amount of used oil set by the setting window 62 is discharged, the flow meter 36 detects the discharge of used oil, and thus the solenoid operated valve 32 goes into the state of normally closed while the solenoid operated valve 48 goes into the state of normally open. Therefore, oil in the automatic transmission 10 cannot be discharged and introduced into the used oil tank 34 any more, and fresh oil is continuously supplied until an amount of the fresh oil reaches the set amount. When an amount of fresh oil supplied reaches the set amount, the flow meter 42 detects this and thus the motor pump 46 is stopped. When discharged amount and supplied amount reach the set amount, a buzzer rings five times to notify an operator that the operation is completed.

At this point, if numerical values indicated by the setting window 62, the fresh oil supply window 64 and the used oil discharging window 66 are all correct, the engine of the automobile is stopped and the automatic oil changing apparatus is removed from the automatic transmission 10. As such, the oil changing operation is completed.

If an amount of oil in the automatic transmission, which is measured by an oil level gauge, is eithr insufficient or excessive, an operator can finely adjust the oil amount by means of the fine discharge button 58 and the fine supply button 60. More specifically, if excessive oil is supplied into the automatic transmission, the excess oil is discharged into the used oil tank 34 by pushing the fine discharge button 58. On the other hand, if an amount of oil supplied into the automatic transmission is not sufficient, it is possible to further supply oil to the automatic transmission by pushing the fine supply button. However, the two buttons cannot be actuated during an operation of the automatic oil changing apparatus but can be actuated to be finely adjusted in only a circulation mode.

In FIG. 5, reference numeral 53 designates a power switch for turning on or off an electric power supply, and reference numeral 68 designates a temperature window for displaying temperature.

Another embodiment of the present invention will now be described.

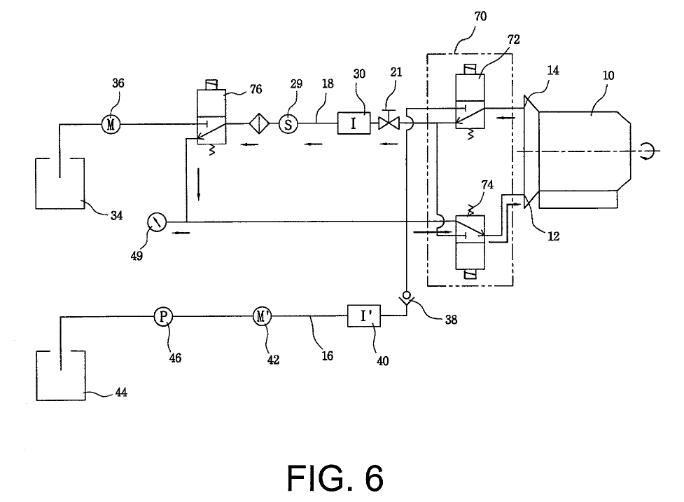

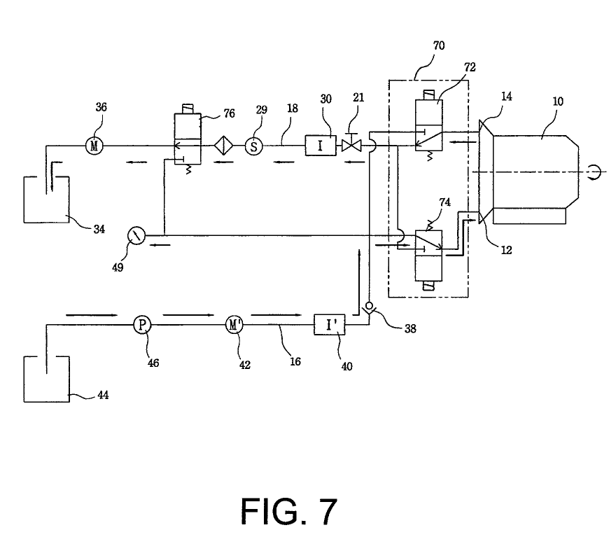

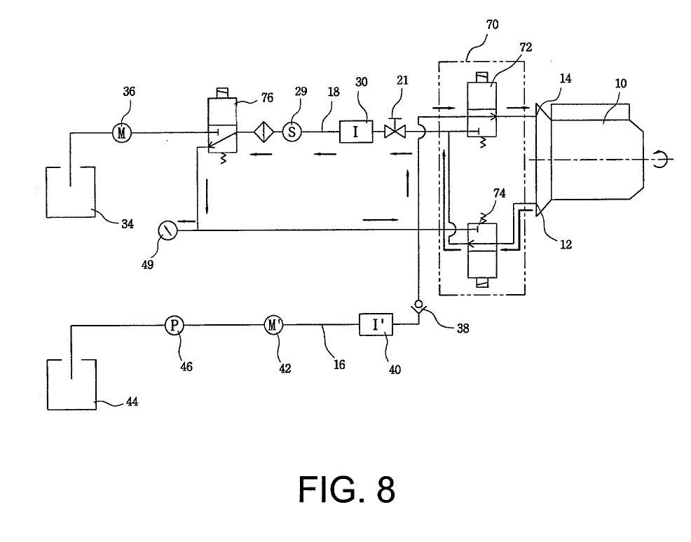

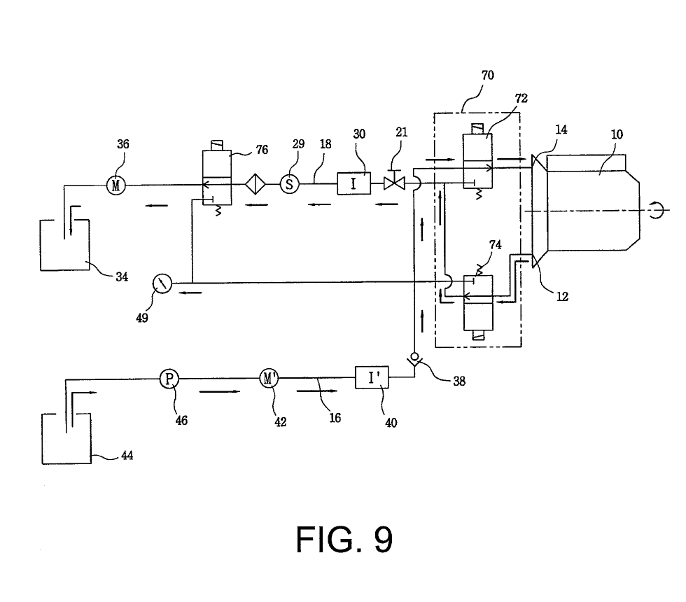

FIG. 6 is a circuit diagram of a second embodiment of the present invention, which has functions similar to those of the first embodiment shown in FIG. 1, FIG. 7 is a circuit diagram of the second embodiment, which has functions similar to those of the first embodiment shown in FIG. 2, FIG. 8 is a circuit diagram of the second embodiment, which has functions similar to those of the first embodiment shown in FIG. 3, and FIG. 9 is a circuit diagram of the second embodiment, which has functions similar to those of the first embodiment shown in FIG. 4.

This second embodiment of the present invention is adapted to use three three-way solenoid operated valves 72, 74 and 76 instead of the six two-way solenoid operated valves. The three-way solenoid operated valve 72 functions similarly to the two-way solenoid operated valves 22 and 26 of the first embodiment, the three-way solenoid operated valve 74 functions similarly to the two-way solenoid operated valves 24 and 28 of the first embodiment, and the three-way solenoid operated valve 76 functions similarly to the two-way solenoid operated valves 32 and 48 of the first embodiment. By so doing, since each of the oil supply line 16 and the oil discharge line 18 of the oil line changing unit 70 can be comprised of one line, the configuration of the apparatus can be more simplified. Since the other components of this embodiment are the same as those of the first embodiment, their detailed description is omitted.

An amount of oil supplied from the fresh oil tank 44 is previously set. Accordingly, when the flow meter 42 detects the fact that the set amount of oil is supplied, the motor pump 46 is not operated any more. When the automatic oil changing apparatus is intended to be operated again, the motor pump 46 can be operated only by resetting an amount of oil to be supplied. For example, where a certain oil company lends the automatic oil changing apparatus for free in order to expand its market share, the oil changing apparatus is set to an amount of oil sold by the oil company. When the set amount of oil is fully consumed, the flow meter 42 for fresh oil detects the oil consumption and stops the operation of the motor pump. When it is intended to use the oil changing apparatus again, the motor pump may be operated only after the oil changing apparatus is reset to an amount of oil sold by the oil company, thereby precluding the lessor from using oil from other oil companies.

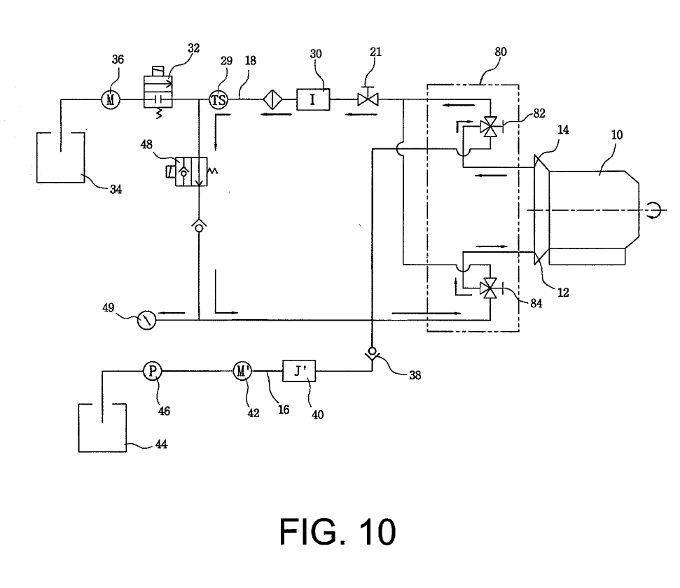

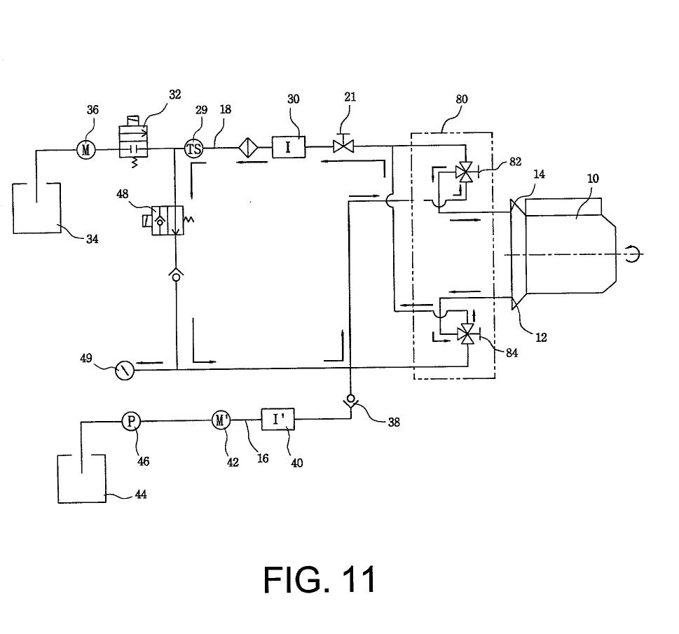

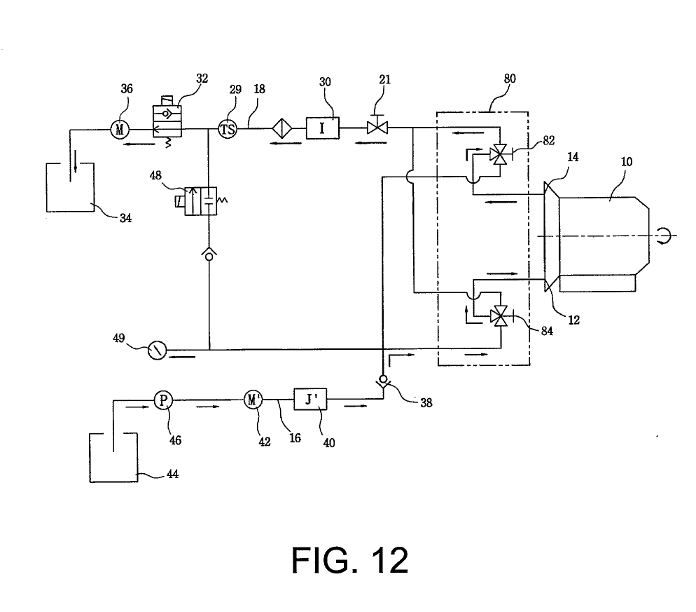

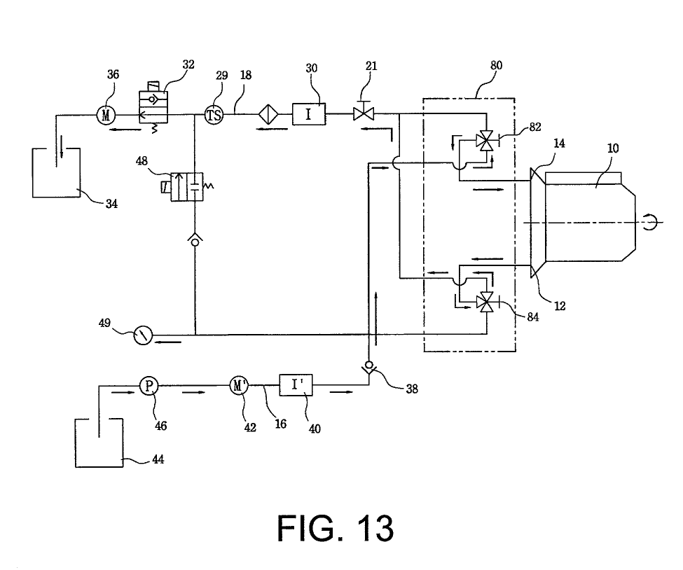

FIGS. 10 to 13 show a further embodiment of the present invention. More specifically, FIG. 10 is a circuit diagram of a third embodiment showing a state of forward connection by two manual three-way valves in which oil is circulated, FIG. 11 is a circuit diagram of the third embodiment showing a state of reverse connection by two manual three-way valves in which oil is circulated, FIG. 12 is a circuit diagram of the third embodiment showing a state of forward connection by two manual three-way valves in which oil is changed, and FIG. 13 is a circuit diagram of the third embodiment showing a state of reverse connection by two manual three-way valves in which oil is changed.

This third embodiment of the present invention shown in FIGS. 10 to 13 is adapted to use two manual three-way solenoid operated valves 82 and 84 instead of the six two-way solenoid operated valves in the first embodiment. The manual three-way solenoid operated valve 82 functions similarly to the two-way solenoid operated valves 22 and 26 of the first embodiment, and the manual three-way solenoid operated valve 84 functions similarly to the two-way solenoid operated valves 24 and 28 of the first embodiment. By so doing, each of the oil supply line 16 and the oil discharge line 18 of the oil line changing unit 80 can be comprised of one line. Furthermore, since the oil changing apparatus can be manually operated if required, a structure of the apparatus required for circulation and changing of oil can be more simplified. Since the other components of this embodiment are the same as those of the above embodiments, their detailed description is omitted.

As described above, the present invention provides an automatic oil changing apparatus for an automatic transmission of an automobile which is capable of easily changing oil by automatically changing directions of solenoid operated valves of an oil line changing unit without disconnection of the apparatus, hoisting of an automobile and stopping of an engine, even though the automatic oil changing apparatus is not correctly connected to the automatic transmission, thereby improving efficiency of an oil changing operation and operational convenience.

Furthermore, since the automatic oil changing apparatus according to the present invention is adapted to prevent supply of fresh oil in the initial stage of an oil changing procedure until a certain amount of used oil is discharged, it is possible to minimize unnecessary consumption of fresh oil during an oil changing operation.

According to the present invention, since the automatic oil changing apparatus is capable of manually adjusting a supplied amount of fresh oil and a discharged amount of used oil when the supplied amount of fresh oil and the discharged amount of used oil are not identical to the initial setting amount after an oil changing operation, it is possible to fulfill a precise oil changing operation.

In addition, since an oil changing operation is automatically carried out and completion of the operation is indicated by a buzzer sound, it is possible to eliminate inconvenience and time loss accompanied by a manual oil changing operation. Accordingly, an operator can easily carry out an oil changing operation while carrying out another operation.

Moreover, the oil changing apparatus according to the present invention enables an operator to identify breakdown of an automatic transmission by measuring temperature of the transmission by means of a temperature sensor.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An automatic oil changing apparatus for an automatic transmission of an automobile comprising:
an oil line changing unit which includes first and second double lines connected to a supply line and a discharge line of the automatic transmission, branch lines of each of the first and second double lines being connected to an oil inlet and an oil outlet of the automatic transmission, respectively, and which further includes four two-way solenoid operated valves provided at the branch lines of the first and second double lines, respectively, such that the two two-way solenoid operated valves provided at each of the first and second double lines are opposite to each other in flow direction and are adapted to allow supply and discharge of oil in the state of forward connection and to be changed with each other in flow direction in the state of reverse connection;
a solenoid operated valve connected to the discharge line of the oil line changing unit to interrupt discharge of oil when initial oil pressure of the automatic transmission is checked;
a used oil tank connected to a rear end of the solenoid operated valve;
a motor pump connected to the supply line of the oil line changing unit to supply oil;
a fresh oil tank connected to a rear end of the motor pump;
a solenoid operated valve provided between the supply line and the discharge line, which is adapted to be opened when initial pressure of the automatic transmission is checked and to be closed when discharge and supply of oil are initiated; and
a pressure gauge connected in series to the solenoid operated valve provided between the supply line and the discharge line to check pressure of oil in the automatic transmission.

2. The automatic oil changing apparatus as set forth in claim 1, in which the motor pump is operated to supply fresh oil when the discharge of a certain amount of used oil is detected by a flow meter.

3. The automatic oil changing apparatus as set forth in claim 1, further comprising a control valve, which is connected in series between the oil line changing unit and an indicator to control discharged amount of oil when an amount of oil discharged is more than an amount of fresh oil supplied.

4. The automatic oil changing apparatus as set forth in claim 1, further comprising a temperature sensor, which is connected in series between the indicator and the solenoid operated valve connected to the discharge line of the oil line changing unit to measure temperature of the automatic transmission.

5. The automatic oil changing apparatus as set forth in claim 1 or 2, in which, where oil is excessively supplied into the automatic transmission after completion of an oil changing operation, the excess oil is discharged to the used oil tank by pushing a fine discharge button, and where oil supplied to the automatic transmission is not sufficient, fresh oil is further supplied by pushing a fine supply button.

6. The automatic oil changing apparatus as set forth in claim 1 or 2, in which an amount of oil supplied from the fresh oil tank is previously set, and the motor pump is not operated any more when the supply of the set amount of oil is detected by a flow meter while the motor pump is operated to restart the automatic oil changing apparatus when an amount of oil to be supplied is reset.

7. An automatic oil changing apparatus for an automatic transmission of an automobile comprising:
an oil line changing unit which includes two three-way solenoid operated valves provided at a supply line and a discharge line of the automatic transmission connected to an oil inlet and an oil outlet of an automatic transmission such that the two three-way solenoid operated valves are opposite to each other in flow direction and are adapted to allow supply and discharge of oil in the state of forward connection, and to be changed with each other in flow direction in the state of reverse connection;
a solenoid operated valve connected to the supply line and the discharge line of the oil line changing unit, which is adapted to be opened when initial pressure of the automatic transmission is checked and to be closed when discharge and supply of oil are initiated;
a used oil tank connected to a rear end of the solenoid operated valve;
a motor pump connected to the supply line of the oil line changing unit to supply oil;
a fresh oil tank connected to a rear end of the motor pump; and
a pressure gauge connected between the solenoid operated valve and the supply line to check pressure of oil in the automatic transmission.
